(19) United States
(12) Patent Application Publication
(10) Pub. No.: US 2026/0071628 A1
(43) Pub. Date: Mar. 12, 2026

(54) ADAPTIVE FAULT PREDICTION COOLING FAN SYSTEM AND CONTROL METHOD THEREOF

(71) Applicant: Richtek Technology Corporation, Hsinchu (TW)

(72) Inventors: Shih-Jen YANG, New Taipei (TW); Tao-Yen WEI, Taoyuan (TW); I-Chi LIN, New Taipei (TW)

(21) Appl. No.: 19/226,132

(22) Filed: Jun. 2, 2025

Related U.S. Application Data
(60) Provisional application No. 63/691,353, filed on Sep. 6, 2024.

(30) Foreign Application Priority Data
Jan. 22, 2025 (TW) 114102693

(51) Int. Cl. F04D 27/00; G05B 23/02

(52) U.S. Cl. CPC F04D 27/001; G05B 23/0235

(57) ABSTRACT

A cooling fan system includes: multiple fan circuits for driving corresponding multiple fan devices according to corresponding PWM signals; and a management controller for controlling and adjusting the multiple fan circuits to detect a fault prediction status of the multiple fan circuits. During a test procedure, the management controller performs feedback control of a current rotational speed vector of the multiple fan circuits to a target rotational speed vector according to a rotational speed feedback signal returned from each of the multiple fan circuits, and establishes a system coefficient table based on a predetermined electrical parameter vector corresponding to the target rotational speed vector. During an operation procedure, the management controller determines an operation rotational speed vector according to an environmental condition, and performs feedback control of the current rotational speed vector to the operation rotational speed vector, and detects the fault prediction status based on the system coefficient table.

### CROSS REFERENCE

The present invention claims priority to the provisional application Ser. No. 63/691,353, filed on Sep. 6, 2024 and claims priority to the TW patent application No. 114102693, filed on Jan. 22, 2025.

### BACKGROUND OF THE INVENTION

### Field of Invention

The present invention relates to a cooling fan system, and more particularly to a cooling fan system capable of adaptive fault prediction. The present invention also relates to a control method for controlling the above cooling fan system.

### Description of Related Art

Cooling fan systems are widely applied in servers, data centers, and high-performance electronic devices, and is primarily configured to maintain the devices operating within a suitable temperature range. Such a system typically includes a control unit, such as a baseboard management controller (BMC), configured to adjust a rotational speed of a fan according to a temperature of the device or an environmental condition, so as to meet heat dissipation demands. The control unit controls the rotational speed of the fan through a pulse width modulation (PWM) signal and receives a feedback signal from the fan to monitor an operational state of the fan. Some systems are further equipped with a sensing device configured to detect electrical parameters (such as a driving current or a driving voltage) of the fan to further evaluate a health status of the fan.

However, a drawback of the cooling fan systems of prior art is that most of the prior art can only issue an alert after a fan exhibits an obvious fault, and cannot predict the fault in advance. In addition, a test procedure of the prior art is also a major challenge, wherein the process requires manually testing the rotational speed and the electrical parameters of the fan one by one, which is excessively time-consuming and costly for large-scale testing, and may even be impractical in actual applications.

Compared to the prior art described above, the present invention provides a cooling fan system capable of adaptive fault prediction, offering an innovative solution to the aforementioned problems. By establishing a system coefficient table during a test procedure, a baseboard management controller can dynamically monitor a current operational state of the fan during a daily operation process and detect a fault prediction status of multiple fan circuits based on an electrical parameter threshold, so as to predict faults of the multiple fan circuits. Furthermore, an adaptive test procedure built into the present invention can automatically test and establish the system coefficient table of the multiple fan circuits, greatly simplifying the complexity of the testing process, and enabling efficient completion even for a wide testing scope.

Through the innovative design described above, the present invention effectively overcomes the shortcomings of conventional cooling fan systems, significantly enhances the efficiency, reliability, and maintainability of the system, and provides a more stable and reliable heat dissipation solution for high-performance electronic devices.

### SUMMARY OF THE INVENTION

From one perspective, the present invention provides a cooling fan system capable of adaptive fault prediction, comprising: multiple fan circuits, including multiple fan devices correspondingly, and configured to drive the corresponding multiple fan devices according to corresponding pulse width modulation (PWM) signals; and a management controller, configured to control and adjust the multiple fan circuits during a test procedure and an operation procedure, respectively, so as to detect a fault prediction status of the multiple fan circuits; wherein during the test procedure, the management controller is configured to perform feedback control of a current rotational speed vector of the multiple fan circuits to a target rotational speed vector according to a rotational speed feedback signal returned from each of the multiple fan circuits, and to establish a system coefficient table based on a predetermined electrical parameter vector corresponding to the target rotational speed vector, wherein the predetermined electrical parameter vector is returned from the multiple fan circuits, and wherein the system coefficient table includes the target rotational speed vector and the corresponding predetermined electrical parameter vector or a corresponding electrical parameter threshold vector; wherein during the operation procedure, the management controller is configured to determine an operation rotational speed vector according to an environmental condition, and configured to perform feedback control of the current rotational speed vector of the multiple fan circuits to the operation rotational speed vector, and subsequently configured to detect the fault prediction status of the multiple fan circuits based on the system coefficient table, wherein the fault prediction status corresponds to a condition in which a current electrical parameter vector of the multiple fan circuits exceeds the electrical parameter threshold vector.

In one embodiment, the target rotational speed vector is determined according to a rotational speed range vector, wherein the rotational speed range vector includes multiple target rotational speed vectors.

In one embodiment, the rotational speed range vector is determined according to a system default or by a user.

In one embodiment, the system coefficient table includes an individual system coefficient table for each of the multiple fan circuits; wherein in the individual system coefficient table corresponding to a selected one of the multiple fan circuits, the target rotational speed vector includes multiple target rotational speeds of the selected fan circuit and a fixed target rotational speed of others of the multiple fan circuits, and the predetermined electrical parameter vector includes multiple predetermined electrical parameters of the selected fan circuit; wherein the individual system coefficient table of the selected fan circuit is established according to the multiple target rotational speeds of the selected fan circuit, the fixed target rotational speed of the others of the multiple fan circuits, predetermined electrical and the corresponding multiple parameters.

In one embodiment, the system coefficient table includes an individual system coefficient table for each of the multiple fan circuits; wherein in the individual system coefficient table corresponding to each of the multiple fan circuits, the target rotational speed vector includes multiple target rotational speeds of all the multiple fan circuits, and the predetermined electrical parameter vector includes multiple predetermined electrical parameters of all the multiple fan circuits; wherein the individual system coefficient table for each of the multiple fan circuits is established according to the multiple target rotational speeds of all the multiple fan circuits and the corresponding multiple predetermined electrical parameters.

In one embodiment, the management controller is configured to communicate with the multiple fan circuits through a serial bus communication method so as to control and adjust the multiple fan circuits and detect the fault prediction status of the multiple fan circuits.

In one embodiment, the cooling fan system further comprises: multiple bus control circuits correspondingly coupled to the multiple fan circuits, configured to communicate with the management controller through a serial data line and a serial clock line, so as to control and adjust the multiple fan circuits and detect the fault prediction status of the multiple fan circuits.

In one embodiment, the system coefficient table established during the test procedure is stored in the management controller, the multiple fan circuits, or the multiple bus control circuits.

In one embodiment, the management controller includes multiple first multiplexing pins, configured to transmit the multiple PWM signals to the corresponding multiple fan circuits in a driving mode, and to transmit multiple clock signals to the corresponding multiple fan circuits in a communication mode; and multiple second multiplexing pins, configured to receive a current rotational speed vector returned from the corresponding multiple fan circuits in the driving mode so as to perform feedback control of the current rotational speed vector according to the target rotational speed vector, and configured to receive the predetermined electrical parameter vector or a current electrical parameter vector returned from the corresponding multiple fan circuits in the communication mode so as to detect the fault prediction status of the multiple fan circuits.

In one embodiment, during the operation procedure, the management controller is further configured to read or calculate the electrical parameter threshold vector corresponding to the operation rotational speed vector according to the system coefficient table so as to detect the fault prediction status of the multiple fan circuits.

In one embodiment, the environmental condition includes system temperature, system load, or airflow resistance of the cooling fan system.

In one embodiment, the current electrical parameter vector includes driving current, driving voltage, or duty of each of the multiple fan circuits.

In one embodiment, the current rotational speed vector of the multiple fan circuits is positively correlated with the current electrical parameter vector.

In one embodiment, the system coefficient table established during the test procedure is stored in the management controller or the multiple fan circuits.

From another perspective, the present invention provides a control method for controlling a cooling fan system, wherein the cooling fan system includes multiple fan circuits and a management controller, wherein the multiple fan circuits are configured to drive corresponding multiple fan devices according to corresponding multiple pulse width modulation (PWM) signals, and the management controller is configured to detect a fault prediction status of the multiple fan circuits; the control method comprising during a test procedure, performing feedback control of a current rotational speed vector of the multiple fan circuits to a target rotational speed vector according to a rotational speed feedback signal returned from each of the multiple fan circuits, and establishing a system coefficient table based on a predetermined electrical parameter vector corresponding to the target rotational speed vector, wherein the predetermined electrical parameter vector is returned from the multiple fan circuits, and wherein the system coefficient table includes the target rotational speed vector and the corresponding predetermined electrical parameter vector or a corresponding electrical parameter threshold vector; and during an operation procedure, determining an operation rotational speed vector according to an environmental condition, and performing feedback control of the current rotational speed vector of the multiple fan circuits to the operation rotational speed vector, and subsequently detecting the fault prediction status of the multiple fan circuits based on the system coefficient table, the wherein fault prediction status corresponds to a condition in which a current electrical parameter vector of the multiple fan circuits exceeds the electrical parameter threshold vector.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of an embodiment of a cooling fan system according to the present invention.

FIG. 2A and FIG. 2B show characteristic curve diagrams of driving currents with rotational speeds, and duty cycles with rotational speeds, respectively, according to an embodiment of the present invention.

FIG. 3 shows a schematic diagram of another embodiment of a fan circuit of the cooling fan system according to the present invention.

FIG. 4 shows a schematic diagram of another embodiment of a cooling fan system according to the present invention.

FIG. 5 shows a schematic diagram of still another embodiment of a cooling fan system according to the present invention.

FIG. 6 shows a flowchart of a test procedure of a cooling fan system according to an embodiment of the present invention.

FIG. 7A to FIG. 7C show three embodiments of rotational speed range vectors of the cooling fan system according to the present invention.

FIG. 8 shows a flowchart of an operation procedure of the cooling fan system according to an embodiment of the present invention.

FIG. 9 shows one embodiment of a system coefficient table of the cooling fan system according to the present invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

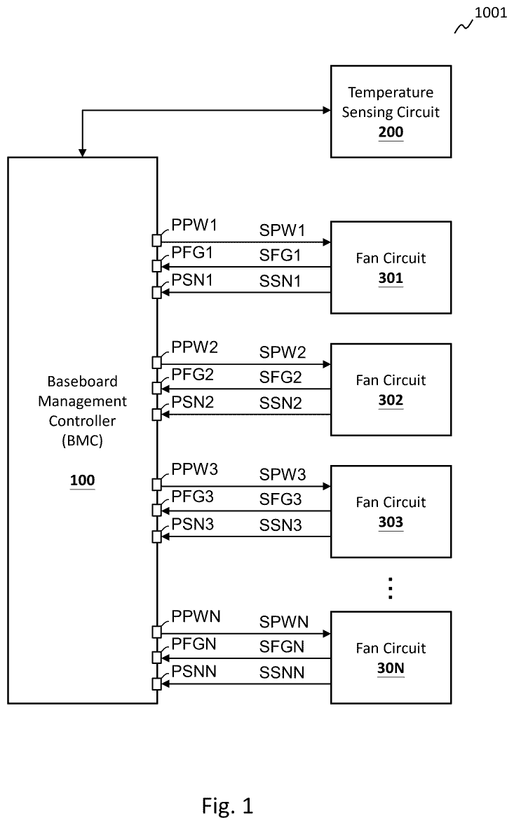

FIG. 1 shows a schematic diagram of an embodiment of a cooling fan system according to the present invention. In one embodiment, a cooling fan system 1001 in FIG. 1 comprises a management controller, a temperature sensing circuit 200, and multiple fan circuits (for example, fan circuits 301, 302, 303, and 30N, where N is a positive integer greater than 1). In a specific embodiment, the cooling fan system 1001 is, for example, a cooling fan system for a server, and the management controller is configured as a baseboard management controller (BMC) 100.

In one embodiment, the baseboard management controller 100 is configured to control and adjust operations of the multiple fan circuits, and is coupled to the corresponding multiple fan circuits through the following pins: (1) transmitting multiple pulse width modulation (PWM) signals (e.g. SPW1, SPW2, SPW3, and SPWN) via multiple PWM pins (e.g. PPW1, PPW2, PPW3, and PPWN); (2) receiving multiple rotational speed feedback signals (e.g. SFG1, SFG2, SFG3, and SFGN) via multiple feedback signal pins (e.g. PFG1, PFG2, PFG3, and PFGN); and (3) receiving multiple sensing signals (e.g. SSN1, SSN2, SSN3, and SSNN) via multiple sensing pins (e.g. PSN1, PSN2, PSN3, and PSNN).

In one embodiment, the temperature sensing circuit 200 is configured to detect an internal environmental temperature of a server and transmit corresponding information to the baseboard management controller 100, so as to provide a reference for controlling fan operations. In one embodiment, the multiple fan circuits (301 to 30N) are configured to receive the multiple PWM signals (SPW1 to SPWN) transmitted by the baseboard management controller 100 and return the multiple rotational speed feedback signals (SFG1 to SFGN). Additionally, the multiple fan circuits are configured to transmit the multiple sensing signals (SSN1 to SSNN) to the baseboard management controller 100. In one embodiment, the multiple rotational speed feedback signals (SFG1 to SFGN) indicate a current rotational speed vector of the multiple fan circuits, allowing the baseboard management controller 100 to obtain the current rotational speed of each of the multiple fan circuits according to the multiple rotational speed feedback signals. In one embodiment, the multiple sensing signals are configured to indicate electrical characteristics such as driving current, driving voltage, or duty of each of the multiple fan circuits, so as to perform subsequent analysis and fault prediction.

In one embodiment, the cooling fan system 1001 establishes and uses a system coefficient table through a test procedure and an operation procedure to detect a fault prediction status of the multiple fan circuits.

In one embodiment, during the test procedure, the baseboard management controller 100 transmits the multiple PWM signals (SPW1 to SPWN) to the corresponding multiple fan circuits (301 to 30N) respectively through the multiple PWM pins (PPW1 to PPWN) according to a target rotational speed vector so as to drive or adjust the rotational speeds of the multiple fan circuits. In one embodiment, the baseboard management controller 100 adjusts the multiple PWM signals (SPW1 to SPWN) based on the target rotational speed vector and a current rotational speed vector indicated by the multiple rotational speed feedback signals (SFG1 to SFGN), so as to perform feedback control of the current rotational speed vector to the target rotational speed vector.

In one embodiment, through the feedback control described above, after the multiple rotational speed feedback signals (SFG1 to SFGN) returned from the multiple fan circuits are consistent with the target rotational speed vector and the rotational speeds have stabilized, the baseboard management controller 100 obtains and records electrical parameters (such as current or voltage) according to the sensing signals (SSN1 to SSNN) as a predetermined electrical parameter vector corresponding to the target rotational speed vector. In one embodiment, based on one or more sets of the target rotational speed vector and the corresponding predetermined electrical parameter vector, or based on an electrical parameter threshold vector further calculated from the predetermined electrical parameter vector, a system coefficient table is established. Specific embodiments will be described later.

It should be noted that the test procedure is typically performed during system initialization or under specific circumstances to establish or update the system coefficient table, while the operation procedure is performed during actual system operation to detect the status of the multiple fan circuits based on the system coefficient table and to predict faults. It should further be noted that the “fault prediction” referred to in the present invention indicates that any of the current electrical in current electrical parameters the fan circuits exceeds a parameter vector of the multiple corresponding electrical parameter threshold in the electrical parameter threshold vector. A range of the electrical parameter threshold can be set slightly narrower than an actual fault threshold range of a fan circuit to leave sufficient tolerance margin, thereby enabling prediction of a potential fault before an actual failure occurs, allowing for advance maintenance, inspection, or replacement.

In one embodiment, after completion of the test procedure, the system enters the operation procedure. In one embodiment, during the operation procedure, the baseboard management controller 100 determines an operation rotational speed vector based on an environmental condition (for example, temperature, system load, or airflow resistance returned from the temperature sensing circuit 200). Then, the baseboard management controller 100 adjusts the multiple PWM signals (SPW1 to SPWN) based on a difference between the operation rotational speed vector and a current rotational speed vector indicated by the multiple rotational speed feedback signals (SFG1 to SFGN), thereby performing feedback control of the current rotational speed vector to the operation rotational speed vector. In one embodiment, after the current rotational speed vector of the multiple fan circuits reaches and stabilizes at the operation rotational speed vector, the baseboard management controller 100 obtains the corresponding current electrical parameter vector (such as present current or voltage) based on the sensing signals (SSN1 to SSNN), and reads or calculates an electrical parameter threshold vector corresponding to the operation rotational speed vector from the system coefficient table. In one embodiment, if at least one of the current electrical parameters of the multiple fan circuits exceeds (either higher or lower than) the corresponding threshold range, the baseboard management controller 100 determines that the corresponding fan circuit may be in a fault prediction status and generates a fault prediction notification to alert maintenance personnel for inspection or replacement.

For example, in a specific embodiment, based on the system coefficient table, when a rotational speed of the fan circuit 303 is 3000 RPM, a normal driving current indicated by a predetermined electrical parameter is approximately 2.5A, and a corresponding electrical parameter threshold range is from 2.3A to 2.8A. If the baseboard management controller 100 actually reads a current of the fan circuit 303 that is lower than 2.3A or higher than 2.8A, it indicates that the fan circuit 303 is in a fault prediction status, thus determining that the fan circuit 303 is abnormal. In one embodiment, the baseboard management controller 100 generates a fault prediction notification based on the fault prediction status of the fan circuit 303 and reports it to maintenance personnel for prompt maintenance, inspection, or replacement to ensure stable operation of the system.

It is noteworthy that after the aforementioned maintenance or replacement, the system coefficient table can be promptly and efficiently updated through the test procedure described above.

In summary, the cooling fan system of the present invention is capable of establishing or updating a system coefficient table through a test procedure, and subsequently dynamically detecting and predicting a fault status during an operation procedure. When at least one of the multiple fan circuits has any current electrical parameter that exceeds a corresponding electrical parameter threshold, the baseboard management controller 100 can immediately generate a notification and perform maintenance, thereby improving the stability and reliability of electronic device operation.

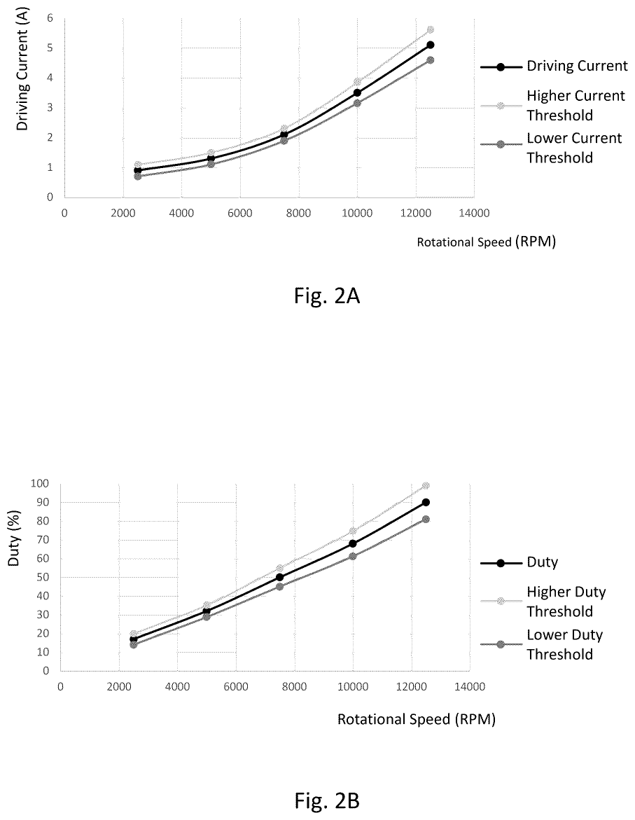

FIG. 2A and FIG. 2B show characteristic curve diagrams of driving currents with rotational speeds, and duty with rotational speeds, respectively, according to an embodiment of the present invention. It should be noted that, in some embodiments, the electrical parameters related to the rotational speed mentioned above include driving current values or driving voltage values, and the electrical parameter thresholds include driving current thresholds or driving voltage thresholds. As shown in FIG. 2A, the driving current thresholds include a high current threshold and a low current threshold. In addition, the electrical parameters related to the rotational speed may also be the duty of the PWM signals, and the electrical parameter thresholds may include duty thresholds. As shown in FIG. 2B, the duty thresholds include high duty thresholds and low duty thresholds. Generally, as shown in FIGS. 2A and 2B, the rotational speeds of the fans are positively correlated with the driving currents, the driving voltages, or the duty of the PWM signals.

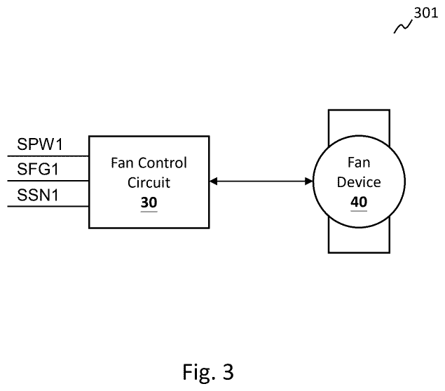

FIG. 3 shows a schematic diagram of another embodiment of a fan circuit of the cooling fan system according to the present invention. In one embodiment, the fan circuits 301 to 30N in FIG. 1 respectively include a fan control circuit and a fan device. For example, in a specific embodiment, as shown in FIG. 3, the fan circuit 301 includes a fan control circuit 30 and a fan device 40. The fan control circuit 30 is configured to generate a driving power according to a PWM signal SPW1 transmitted from the baseboard management controller 100 to drive the fan device 40, and is further configured to sense the rotational speed of the fan device 40 and return a rotational speed feedback signal SFG1 and a sensing signal SSN1.

Specifically, in one embodiment, during the test procedure, the fan control circuit 30 drives the fan device 40 according to the received PWM signal SPW1 and returns the rotational speed feedback signal SFG1 to the baseboard management controller 100 according to the current rotational speed of the fan device 40, so that the baseboard management controller 100 can perform feedback control of the current rotational speed of the fan device 40 to a target rotational speed based on the target rotational speed corresponding to fan circuit 301 and the rotational speed feedback signal SFG1. On the other hand, after the current rotational speed of the fan device 40 has been adjusted to and stabilized at the target rotational speed, the fan control circuit 30 is configured to sense the predetermined electrical parameters such as the driving current and the driving voltage corresponding to the target rotational speed of the fan device 40, and return the sensing signal SSN1 related to the predetermined electrical parameters to the baseboard management controller 100, so that the baseboard management controller 100 establishes a system coefficient table based on the target rotational speed vector and the corresponding predetermined electrical parameter vector or the corresponding electrical parameter threshold vector.

In one embodiment, during the operation procedure, the baseboard management controller 100 transmits the PWM signal SPW1 to the fan control circuit 30 according to the operation rotational speed corresponding to the fan circuit 301, so as to drive the fan device 40, and performs feedback control of the current rotational speed of the fan device 40 to the operation rotational speed based on the rotational speed feedback signal SFG1. After the current rotational speed of the fan device 40 has been adjusted to and stabilized at the operation rotational speed, the baseboard management controller 100 obtains the corresponding current electrical parameter based on the sensing signal SSN1 returned from the fan control circuit 30, and compares the current electrical parameter with the electrical parameter threshold obtained according to the system coefficient table, thereby detecting a fault prediction status of the fan circuit 301. Other details not specifically mentioned above can be deduced from the description of FIG. 1.

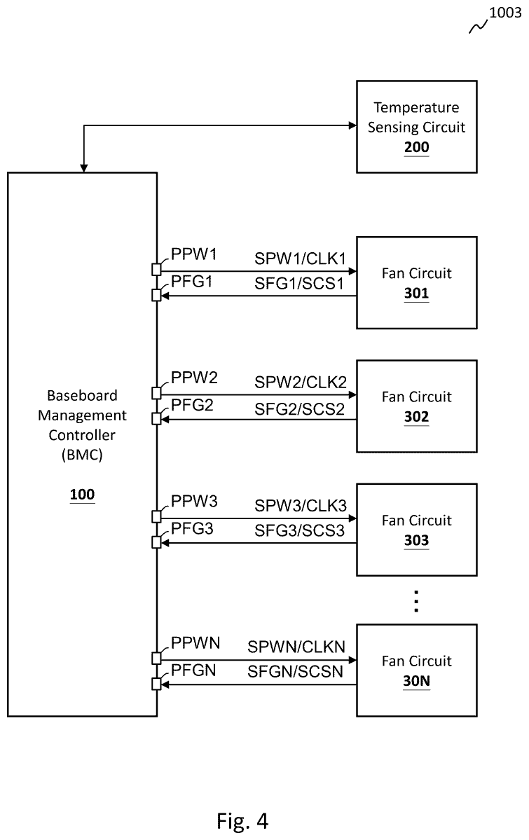

FIG. 4 shows a schematic diagram of another embodiment of a cooling fan system according to the present invention. The cooling fan system 1003 shown in FIG. 4 is similar to the cooling fan system 1001 shown in FIG. 1. The difference is that, in one embodiment, the baseboard management controller 100 of the cooling fan system 1003 is coupled to the multiple fan circuits (301, 302, 303, and 30N) through the corresponding PWM pins (PPW1, PPW2, PPW3, and PPWN) and the feedback signal pins (PFG1, PFG2, PFG3, and PFGN), and omits the additional sensing pins design shown in FIG. 1. In this embodiment, the PWM pins and the feedback signal pins are multiplexing pins, having multifunctional characteristics that can perform different functions in different modes (e.g., in a driving mode and a communication mode), thereby further simplifying hardware configuration and enhancing overall system flexibility.

In one embodiment, in the driving mode, the baseboard management controller 100 transmits multiple PWM signals (SPW1 to SPWN) to the respective corresponding multiple fan circuits (301 to 30N) through the multiple PWM pins (PPW1 to PPWN), so as to drive or adjust the rotational speeds of the multiple fan devices. On the other hand, the multiple fan circuits return multiple rotational speed feedback signals (SFG1 to SFGN) to the baseboard management controller 100 through the feedback signal pins (PFG1 to PFGN), so that the baseboard management controller 100 dynamically adjusts the duty or frequency of the multiple PWM signals based on the rotational speed feedback signals, thereby performing feedback control of the current rotational speed vector of the multiple fan circuits to a target rotational speed vector (during the test procedure) or to an operation rotational speed vector (during the operation procedure). For example, when the baseboard management controller 100 is configured to control the rotational speed of the fan circuit 301 to 2000 RPM, it continuously adjusts the PWM signal SPW1 and reads the rotational speed feedback signal SFG1 in real time. Through stable feedback, the fan circuit 301 can eventually maintain the rotational speed stably at approximately 2000 RPM.

When it is necessary to detect or read an electrical parameter vector (e.g., driving currents, driving voltages, duty, etc.) of the multiple fan circuits for fault prediction, the baseboard management controller 100 switches to a communication mode. In one embodiment, in the communication mode, the PWM pins (PPW1 to PPWN) and the feedback signal pins (PFG1 to PFGN) can be used for serial communication. For example, the PWM pins (PPW1 to PPWN) are configured to transmit corresponding clock signals (such as CLK1, CLK2, CLK3, and CLKN) to the multiple fan circuits (301 to 30N); and the feedback signal pins (PFG1 to PFGN) are configured to receive the sensing signals (such as SCS1, SCS2, SCS3, and SCSN) returned from the multiple fan circuits (301 to 30N). In one embodiment, the sensing signals (SCS1 to SCSN) are digital signals, configured to indicate a predetermined electrical parameter vector corresponding to the target rotational speed vector (when establishing the system coefficient table during the test procedure), or configured to indicate a current electrical parameter vector during the operation procedure. Other operational details not specifically mentioned above can be deduced from the description of FIG. 1 or subsequent embodiments.

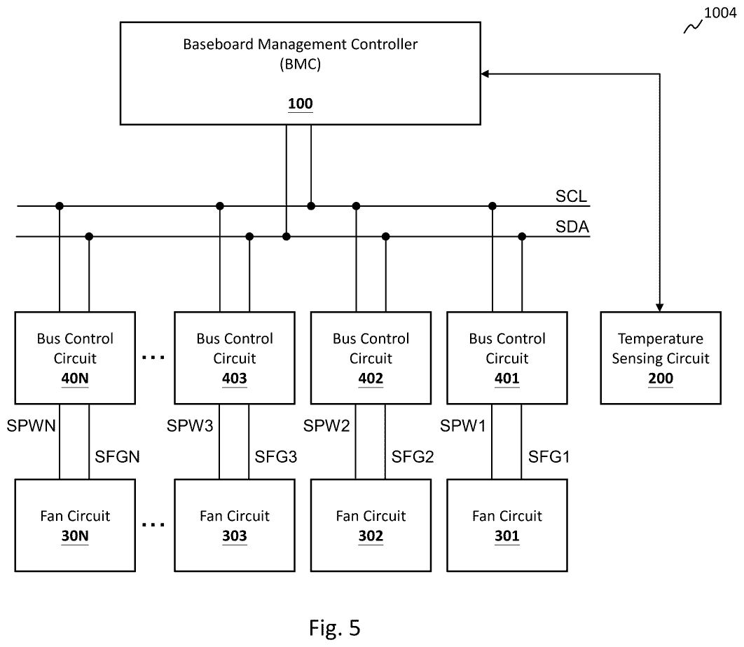

FIG. 5 shows a schematic diagram of another embodiment of a cooling fan system according to the present invention. In one embodiment, as shown in FIG. 5, a cooling fan system 1004 includes multiple bus control circuits (e.g., bus control circuits 401, 402, 403, and 40N) respectively coupled to multiple fan circuits (e.g., fan circuits 301, 302, 303, and 30N), and connected to and communicate with the baseboard management controller 100 through a serial bus communication method, such as I2C (Inter-Integrated Circuit).

In this embodiment, the multiple bus control circuits are configured as bridge devices between the baseboard management controller 100 and the multiple fan circuits. In one embodiment, the baseboard management controller 100 transmits the target rotational speed vector or the operation rotational speed vector to the multiple bus control circuits (401 to 40N) through a serial data line (SDA) and a serial clock line (SCL). In one embodiment, in a driving mode, each of the multiple bus control circuits (401 to 40N) generates a corresponding PWM signal (for example, SPW1 to SPWN) based on the target rotational speed vector or the operation rotational speed vector transmitted by the baseboard management controller 100, so as to drive the corresponding multiple fan circuits (301 to 30N). In one embodiment, each of the multiple bus control circuits (401 to 40N) further adjusts the corresponding PWM signal (SPW1 to SPWN) based on a difference between the target rotational speed vector (or the operation rotational speed vector) and a current rotational speed vector returned from the corresponding fan circuit (as indicated by the rotational speed feedback signals SFG1 to SFGN), thereby adjusting the current rotational speed vector of the multiple fan circuits (301 to 30N) to the target rotational speed vector (or the operation rotational speed vector).

In one embodiment, in the communication mode, the rotational speed feedback signals (SFG1 to SFGN) are configured to indicate a predetermined electrical parameter vector corresponding to the target rotational speed vector of the multiple fan circuits (301 to 30N), or configured to indicate a current electrical parameter vector corresponding to the operation rotational speed vector of the multiple fan circuits (301 to 30N). During the aforementioned test procedure and operation procedure, the predetermined electrical parameter vector, the electrical parameter threshold vector, or the current electrical parameter vector required by the baseboard management controller 100 are all transmitted through the serial data line SDA and the serial clock line SCL via the multiple bus control circuits (401 to 40N). Other operational details not specifically mentioned above can be deduced from the description of FIG. 1 or subsequent embodiments.

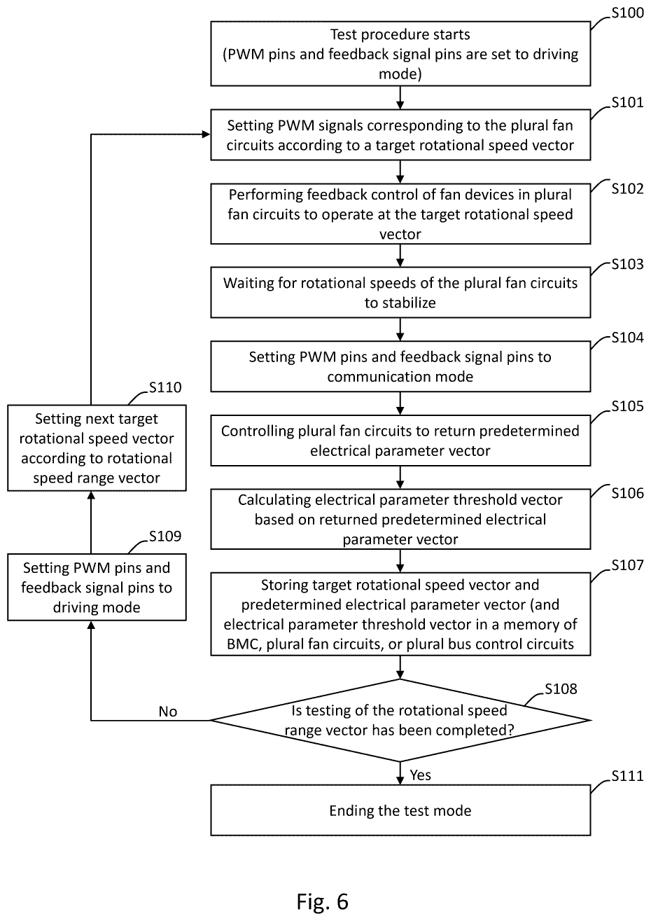

FIG. 6 shows a flowchart of a test procedure of a cooling fan system according to an embodiment of the present invention. In one embodiment, during the test procedure, the baseboard management controller 100 of FIG. 1, FIG. 4, or FIG. 5 is capable of adaptively controlling and adjusting the target rotational speed vector of the multiple fan circuits (e.g., fan circuits 301 to 30N) based on a rotational speed range vector, and receiving the electrical parameter vector returned from the multiple fan circuits. Accordingly, the baseboard management controller 100 can establish an individual system coefficient table corresponding to each of the fan circuits, which serves as a basis for detecting a fault prediction status of the multiple fan circuits during subsequent system operations.

Please refer to FIGS. 4 and 6 simultaneously. The following describes the flow of the test procedure in FIG. 4 according to a specific embodiment. In step S100, the cooling fan system starts the test procedure, and the baseboard management controller 100 initializes the operational state of the multiple fan circuits and sets the PWM pins (PPW1 to PPWN) and the feedback signal pins (PFG1 to PFGN) to the driving mode, so as to drive and adjust the rotational speeds of the multiple fan circuits. In step S101, the baseboard management controller 100 sets the PWM signals corresponding to the multiple fan circuits according to a target rotational speed vector. For example, when the target rotational speed vector is set as (1000 RPM, 8000 RPM, 8000 RPM, 8000 RPM), the target rotational speed corresponding to fan circuit 301 is 1000 RPM, and the target rotational speeds corresponding to fan circuits 302 to 30N are all 8000 RPM.

Then, in step S102, the baseboard management controller 100 performs feedback control of the multiple fan circuits to operate at the target rotational speed vector according to the target rotational speed vector and the current rotational speed vector indicated by the rotational speed feedback signals, and waits for the respective rotational speeds of the multiple fan circuits to stabilize in step S103. For example, when the current rotational speed of the fan circuit 301 is adjusted to 1000 RPM, the baseboard management controller 100 confirms whether the current rotational speed is stabilized based on the rotational speed feedback signal SFG1, such as within a ±50 RPM range.

After the current rotational speeds of the multiple fan circuits are stabilized, in step S104, the baseboard management controller 100 switches the PWM pins and the feedback signal pins to the communication mode to receive the predetermined electrical parameter vector indicated by the sensing signals (SCS1 to SCSN). In step S105, the multiple fan circuits return the predetermined electrical parameter vector through the sensing signals SCS1 to SCSN corresponding to the target rotational speed vector through the feedback signal pins (PFG1 to PFGN). For example, under the target rotational speed vector (1000 RPM, 8000 RPM, 8000 RPM, 8000 RPM), the corresponding driving current vector of the multiple fan circuits is (0.8A, 1.5A, 1.5A, 1.5A), serving as a reference for normal operation. In step S106, the baseboard management controller 100 calculates the electrical parameter threshold vector based on the returned predetermined electrical parameter vector. For instance, if the normal operating current of the fan circuit 301 at 1000 RPM is 0.8A, the current threshold range for fault detection or potential fault can be set as from 0.7A to 0.9A. The relationship between the current threshold and the normal operating current can be defined by an offset value or a proportional relationship.

In step S107, the target rotational speed vector, the predetermined electrical parameter vector, and the electrical parameter threshold vector (that is, the system coefficient table) are stored in a memory for subsequent monitoring and detection of the fault prediction status during the operation procedure. Specifically, the vector data mentioned above can be stored in the memory of the baseboard management controller 100, the multiple fan circuits, or the multiple bus control circuits. After the data is stored, in step S108, the baseboard management controller 100 determines whether the testing of the rotational speed range vector has been completed. For example, if the plan is to test each of the multiple fan circuits at rotational speeds of 1000 RPM, 4000 RPM, and 8000 RPM, and currently only the target rotational speed vector for the fan circuit 301 at 8000 RPM has been tested, it is determined as incomplete, and proceeds to step S109. In the step S109, the baseboard management controller 100 switches the PWM pins and the feedback signal pins back to the driving mode, preparing for the next round of testing. In step S110, the baseboard management controller 100 sets the next target rotational speed vector according to the rotational speed range vector, for example, setting the target rotational speed vector for the fan circuit 302 at 1000 RPM, then returns to the step S101 to set the corresponding PWM signals of the multiple fan circuits according to the target rotational speed vector. This testing is repeated until all the target rotational speed vectors within the rotational speed range vector are completed, then proceeds to a step S111 to end the test mode. At this point, the system coefficient tables of the multiple fan circuits are completely established, and the cooling fan system can proceed to the normal operation procedure.

It should be noted that, in some embodiments, step S106 can be omitted. That is, in the step S107, the system coefficient table established based on the target rotational speed vector and the predetermined electrical parameter vector is directly stored in the memory of the baseboard management controller 100, the multiple fan circuits, or the multiple bus control circuits. Subsequently, during the operation procedure, the electrical parameter threshold vector corresponding to the current rotational speed vector can be calculated based on the system coefficient table, for example, by applying an offset or a proportional relationship, thereby detecting a fault prediction status of the multiple fan circuits.

It should be further noted that the “vector” referred to in the present invention includes multiple data entries, each corresponding to a fan circuit. For example, when the target rotational speed vector for the fan circuits 301 to 30N is (1000 RPM, 8000 RPM, 8000 RPM, 8000 RPM), each value corresponds sequentially to the target rotational speeds of the fan circuits 301, 302, 303, and 30N, respectively. Meanwhile, when the multiple fan circuits stably operate at the target rotational speed vector, the returned predetermined electrical parameter vector can be the driving current vector (0.8A, 1.5A, 1.5A, 1.5A), wherein each value sequentially represents the driving currents of the fan circuits 301, 302, 303, and 30N under the target rotational speeds.

It should be further noted that the rotational speed range vector mentioned above may be quite extensive. In some embodiments, the rotational speed range vector includes multiple target rotational speed vectors. For example, if the rotational speed range of one of the multiple fan circuits ranges from 1000 RPM to 10000 RPM, with an adjustment interval of 1000 RPM each time, the number of rotational speed combination tests required will increase exponentially.

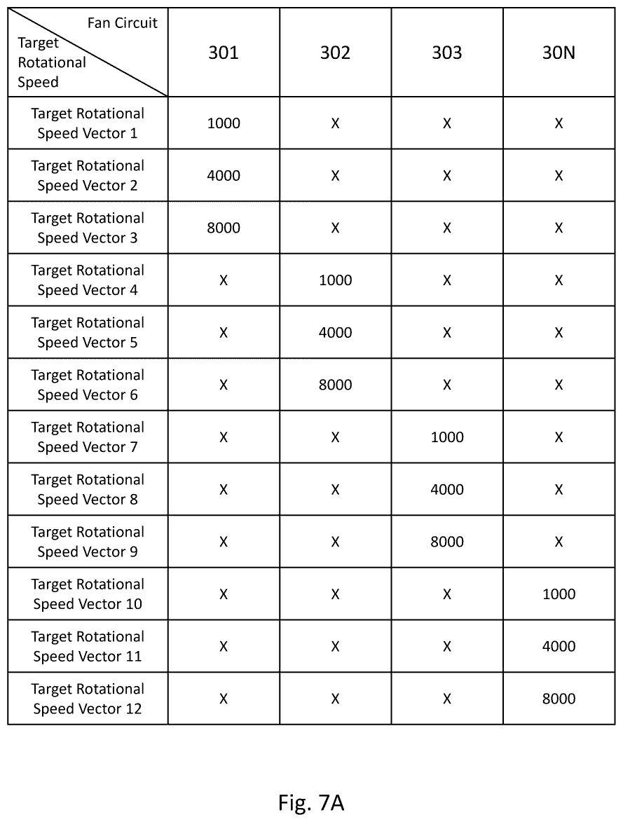

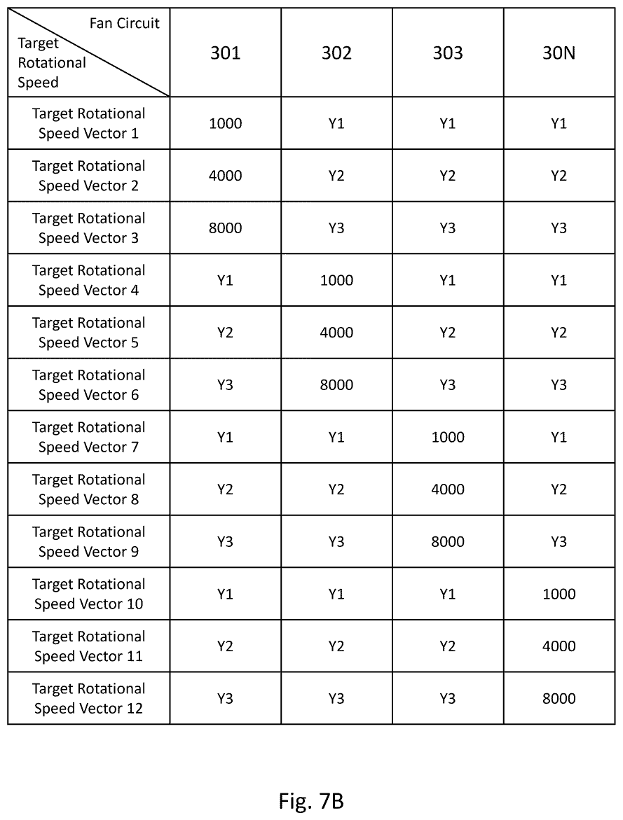

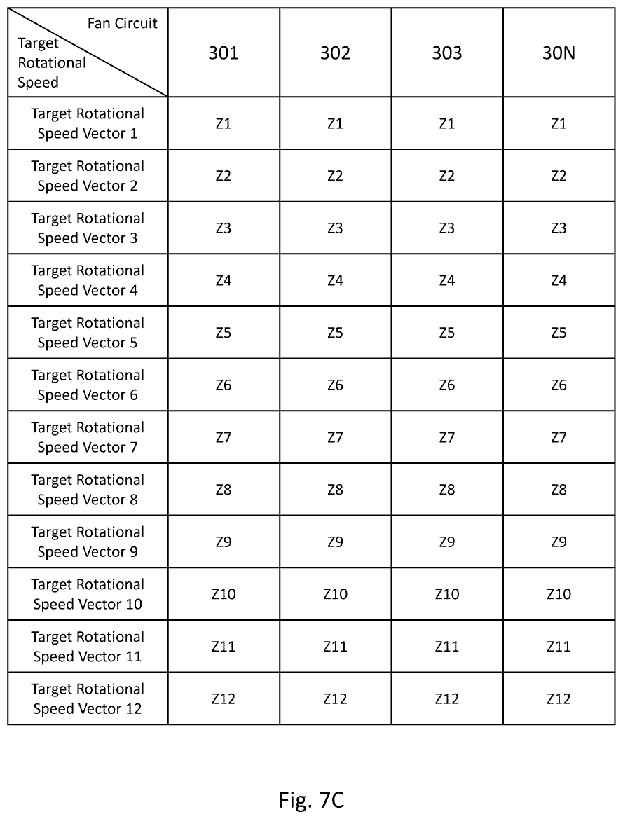

FIGS. 7A to 7C show three embodiments of rotational speed range vectors of the cooling fan system according to the present invention. The construction of the vectors in the present invention can be simple or complex. For example, if it is planned to test the multiple fan circuits at rotational speeds of 1000 RPM, 4000 RPM, and 8000 RPM, when establishing an individual system coefficient table of the fan circuit 301, the target rotational speeds of other fan circuits can be stationary (0 RPM) or fixed at a specific speed (such as a rotational speed X in FIG. 7A). Alternatively, the target rotational speeds of other fan circuits can vary along with the target rotational speed of the fan circuit 301, as shown in FIG. 7B, where when the target rotational speeds of the fan circuit 301 are 1000 RPM, 4000 RPM, and 8000 RPM, the target rotational speeds of the fan circuits 302 to 30N are Y1, Y2, and Y3, respectively. In other embodiments, the rotational speed range vectors of the multiple fan circuits (301 to 30N) can vary simultaneously within the same range, as shown in FIG. 7C, where in a target rotational speed vector 1, the rotational speeds of the multiple fan circuits (301 to 30N) are all Z1, and in a target rotational speed vector 2, the rotational speeds of the multiple fan circuits (301 to 30N) are changed to Z2, and so on up to a target rotational speed vector 12. The values X, Y1 to Y3, and Z1 to Z12 shown in FIGS. 7A to 7C are arbitrary rotational speed values.

It should be noted that the range of the vectors shown in FIGS. 7A to 7C is merely illustrative, and the scope of the present invention is not limited thereto. It should also be noted that, if the rotational speed range vector testing described above were performed manually as in prior art, it would consume excessive resources and might even be impractical in real applications. Therefore, by adopting the adaptive control mechanism of the baseboard management controller 100 in the present invention, the complexity of testing can be effectively reduced, and the testing efficiency can be greatly improved.

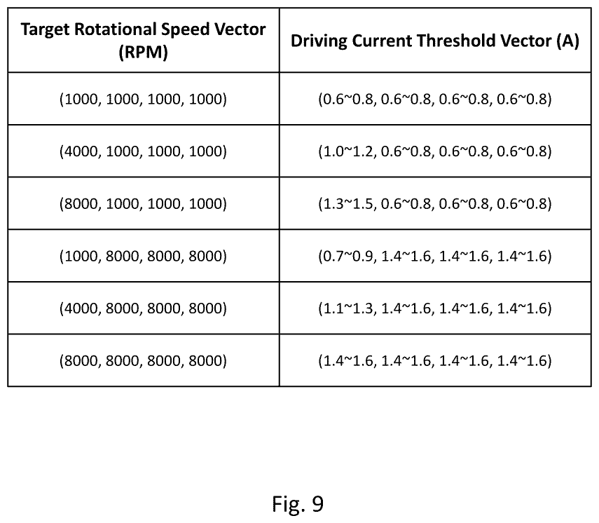

In one embodiment, the system coefficient table is, for example, a correspondence table between the target rotational speed vector and the driving current vector, or between the target rotational speed vector and the driving current threshold vector. FIG. 9 shows one embodiment of a system coefficient table of the cooling fan system according to the present invention. As shown in the system coefficient table of FIG. 9, the independent variable vector is the target rotational speed vector, and the corresponding dependent vector is the driving current threshold vector. Specifically, when the target rotational speed vector of the fan circuits 301 to 30N is (1000 RPM, 8000 RPM, 8000 RPM, 8000 RPM), the corresponding driving current threshold vector is (0.7A˜0.9A, 1.4A˜1.6A, 1.4A˜1.6A, 1.4A˜1.6A); when the target rotational speed vector is (4000 RPM, 8000 RPM, 8000 RPM, 8000 RPM) or (8000 RPM, 8000 RPM, 8000 RPM, 8000 RPM), the corresponding driving current threshold vectors are (1.1A˜1.3A, 1.4A˜1.6A, 1.4A˜1.6A, 1.4A˜1.6A) and (1.4A˜1.6A, 1.4A˜1.6A, 1.4A˜1.6A, 1.4A˜1.6A), respectively.

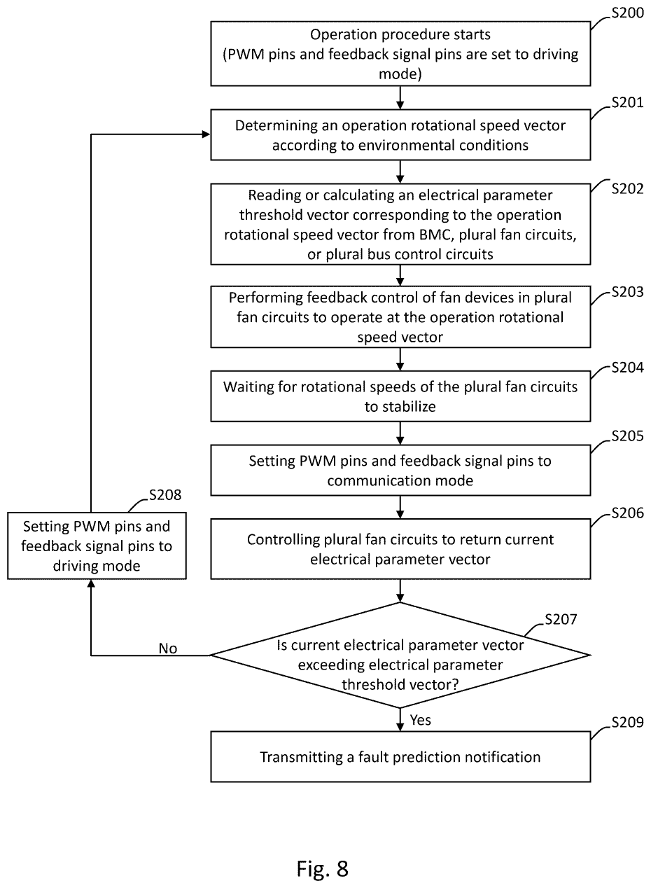

FIG. 8 shows a flowchart of an operation procedure of the cooling fan system according to an embodiment of the present invention. In a specific embodiment, when the cooling fans of the server are initially installed and all fans are operating normally, the cooling fan system firstly performs the test procedure of FIG. 6 to establish the corresponding system coefficient table. After the completion of the test procedure, during the normal operation procedure shown in FIG. 8, the baseboard management controller can detect the fault prediction status of the multiple fan circuits based on the system coefficient table. Please refer to FIGS. 4 and 8. The following describes the flow of the operation procedure in FIG. 4 according to a specific embodiment.

In step S200, the operation procedure begins, and the baseboard management controller 100 sets the PWM pins (PPW1 to PPWN) and the feedback signal pins (PFG1 to PFGN) to the driving mode to ensure that the multiple fan circuits can receive rotational speed control and return their rotational speed statuses.

In step S201, the baseboard management controller 100 determines an operation rotational speed vector according to current environmental conditions. The environmental conditions can include an internal temperature of the server, a processor workload, a system cooling demand, and airflow resistance. For example, in a specific embodiment, when the internal temperature of the server is 45° C. and the processor workload is 50%, the operation rotational speed vector can be set as (2000 RPM, 4000 RPM, 4000 RPM, 4000 RPM) to maintain appropriate cooling performance. If the internal temperature rises to 60° C. and the processor workload increases to 80%, the operation rotational speed vector can be adjusted to (6000 RPM, 8000 RPM, 8000 RPM, 8000 RPM).

In step S202, the baseboard management controller 100 reads or calculates an electrical parameter threshold vector corresponding to the operation rotational speed vector from a memory in the baseboard management controller, the multiple fan circuits, or the multiple bus control circuits. For example, if the operation rotational speed vector is (2000 RPM, 4000 RPM, 4000 RPM, 4000 RPM), the corresponding electrical parameter threshold vector (e.g., the driving current threshold vector) can be (0.9A˜1.1A, 1.3A˜1.5A, 1.3A˜1.5A, 1.3A˜1.5A).

It should be noted that the operation rotational speed vector may not directly correspond to the rotational speeds listed in the system coefficient table established during the test procedure. For instance, if the operation rotational speed vector is (3000 RPM, 5000 RPM, 5000 RPM, 5000 RPM), but the system coefficient table only includes data for 1000 RPM, 4000 RPM, and 8000 RPM, the corresponding electrical parameter threshold vector needs to be calculated. In one embodiment, interpolation methods, such as linear interpolation, can be used to calculate the electrical parameter threshold vector corresponding to the operation rotational speed vector. For example, if the test data shows that the driving current threshold range of the fan circuit 301 is 0.7A to 0.9A at 1000 RPM and 1.1A to 1.3A at 4000 RPM, then the driving current threshold range at 3000 RPM can be calculated by linear interpolation as follows:

$$The lower current threshold : 0.7 A + ( 1.1 A - 0.7 A ) \times ( 3 - 1 ) / ( 4 - 1 ) = 1.03 A$$

$$The higher current threshold : 0.9 A + ( 1.3 A - 0.9 A ) \times ( 3 - 1 ) / ( 4 - 1 ) = 1.23 A$$

These calculated thresholds serve as fallback references for anomaly detection. Similarly, the electrical parameter thresholds for other multiple fan circuits can be calculated accordingly, ensuring that the cooling fan system can still monitor based on reasonable calculation even if the test procedure does not cover all possible rotational speed range vectors. Moreover, the introduction of such calculation methods ensures greater system flexibility, allowing dynamic response to different operating scenarios and providing accurate fault detection capabilities even when complete direct data is not available.

Next, in step S203, the baseboard management controller 100 performs feedback control of the multiple fan circuits to operate at the operation rotational speed vector. For example, the fan circuit 301 is adjusted to 2000 RPM, and the other fan circuits 302 to 30N are adjusted to 4000 RPM, until the multiple fan circuits operate at the target rotational speed vector.

In step S204, the cooling fan system waits for the multiple fan circuits to stabilize at the target rotational speed vector and detects whether the rotational speed fluctuations are within an allowable range, such as within +50 RPM, through the feedback signal pins. After the rotational speeds of the multiple fan circuits are stabilized, the procedure proceeds to the next step.

In step S205, the baseboard management controller 100 switches the PWM pins and the feedback signal pins to the communication mode to receive a current electrical parameter vector corresponding to the operation rotational speed vector from the multiple fan circuits. In step S206, the multiple fan circuits return their current electrical parameter vector, for example, the driving current vector (1.0A, 1.4A, 1.4A, 1.4A).

In step S207, the baseboard management controller 100 determines whether the current electrical parameter vector is within the range of the electrical parameter threshold vector. For example, if the returned current electrical parameter vector is (1.0A, 1.6A, 1.4A, 1.4A), and the electrical parameter threshold (e.g., driving current threshold) for the fan circuit 302 is 1.3A to 1.5A, it is determined that the current electrical parameter of the fan circuit 302 exceeds the electrical parameter threshold, thereby determining the current electrical parameter vector exceeds the electrical parameter threshold vector. Accordingly, the cooling fan system determines that the multiple fan circuits are in a fault prediction status (that is, a fault has occurred or there is a possibility of imminent failure).

If the result of step S207 is yes, indicating that the multiple fan circuits are in the fault prediction status, the procedure proceeds to step S209, where the baseboard management controller 100 transmits a fault prediction notification to alert the system administrator or maintenance personnel to perform maintenance, inspection, or replacement. If the result of step S207 is no, indicating that the current electrical parameter vector of the multiple fan circuits is within the range of the electrical parameter threshold vector, the procedure proceeds to step S208.

In step S208, the baseboard management controller 100 switches the PWM pins and the feedback signal pins back to the driving mode, and then returns to step S201 to determine the next operation rotational speed vector according to the current environmental conditions. Subsequently, the steps after step S202 are repeated, so as to continuously detect whether the multiple fan circuits are in the fault prediction status, thereby ensuring the stability of the system.

The present invention has been described in considerable detail with reference to certain preferred embodiments thereof. It should be understood that the description is for illustrative purposes, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or scaled-down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A cooling fan system capable of adaptive fault prediction, comprising:
multiple fan circuits, including multiple fan devices correspondingly, and configured to drive the corresponding multiple fan devices according to corresponding multiple pulse width modulation (PWM) signals; and
a management controller, configured to control and adjust the multiple fan circuits during a test procedure and an operation procedure, respectively, so as to detect a fault prediction status of the multiple fan circuits;
wherein during the test procedure, the management controller is configured to perform feedback control of a current rotational speed vector of the multiple fan circuits to a target rotational speed vector according to a rotational speed feedback signal returned from each of the multiple fan circuits, and configured to establish a system coefficient table based on a predetermined electrical parameter vector corresponding to the target rotational speed vector, wherein the predetermined electrical parameter vector is returned from the multiple fan circuits, and wherein the system coefficient table includes the target rotational speed vector and the corresponding predetermined electrical parameter vector or a corresponding electrical parameter threshold vector;
wherein during the operation procedure, the management controller is configured to determine an operation rotational speed vector according to an environmental condition, and configured to perform feedback control of the current rotational speed vector of the multiple fan circuits to the operation rotational speed vector, and subsequently configured to detect the fault prediction status of the multiple fan circuits based on the system coefficient table, wherein the fault prediction status corresponds to a condition in which a current electrical parameter vector of the multiple fan circuits exceeds the electrical parameter threshold vector.

2. The cooling fan system of claim 1, wherein the target rotational speed vector is determined according to a rotational speed range vector, wherein the rotational speed range vector includes multiple target rotational speed vectors.

3. The cooling fan system of claim 2, wherein the rotational speed range vector is determined according to a system default or by a user.

4. The cooling fan system of claim 2, wherein the system coefficient table includes an individual system coefficient table for each of the multiple fan circuits; wherein in the individual system coefficient table corresponding to a selected one of the multiple fan circuits, the target rotational speed vector includes multiple target rotational speeds of the selected fan circuit and a fixed target rotational speed of others of the multiple fan circuits, and the predetermined electrical parameter vector includes multiple predetermined electrical parameters of the selected fan circuit; wherein the individual system coefficient table of the selected fan circuit is established according to the multiple target rotational speeds of the selected fan circuit, the fixed target rotational speed of the others of the multiple fan circuits, and the corresponding multiple predetermined electrical parameters.

5. The cooling fan system of claim 2, wherein the system coefficient table includes an individual system coefficient table for each of the multiple fan circuits; wherein in the individual system coefficient table corresponding to each of the multiple fan circuits, the target rotational speed vector includes multiple target rotational speeds of all of the multiple fan circuits, and the predetermined electrical parameter vector includes multiple predetermined electrical parameters of all of the multiple fan circuits; wherein the individual system coefficient table for each of the multiple fan circuits is established according to the multiple target rotational speeds of all of the multiple fan circuits and the corresponding multiple predetermined electrical parameters.

6. The cooling fan system of claim 2, wherein the management controller is configured to communicate with the multiple fan circuits through a serial bus communication method so as to control and adjust the multiple fan circuits and detect the fault prediction status of the multiple fan circuits.

7. The cooling fan system of claim 6, further comprising:
multiple bus control circuits correspondingly coupled to the multiple fan circuits, configured to communicate with the management controller through a serial data line and a serial clock line, so as to control and adjust the multiple fan circuits and detect the fault of the multiple fan circuits.

8. The cooling fan system of claim 7, wherein the system coefficient table established during the test procedure is stored in the management controller, the multiple fan circuits, or the multiple bus control circuits.

9. The cooling fan system of claim 1, wherein the management controller includes:
multiple first multiplexing pins, configured to transmit the multiple PWM signals to the corresponding multiple fan circuits in a driving mode, and to transmit multiple clock signals to the corresponding multiple fan circuits in a communication mode; and
multiple second multiplexing pins, configured to receive a current rotational speed vector returned from the corresponding multiple fan circuits in the driving mode so as to perform feedback control of the current rotational speed vector according to the target rotational speed vector, and configured to receive the predetermined electrical parameter vector or a current electrical parameter vector returned from the corresponding multiple fan circuits in the communication mode so as to detect the fault prediction status of the multiple fan circuits.

10. The cooling fan system of claim 1, wherein during the operation procedure, the management controller is further configured to read or calculate the electrical parameter threshold vector corresponding to the operation rotational speed vector according to the system coefficient table so as to detect the fault prediction status of the multiple fan circuits.

11. The cooling fan system of claim 1, wherein the environmental condition includes system temperature, system load, or airflow resistance of the cooling fan system.

12. The cooling fan system of claim 1, wherein the current electrical parameter vector includes a driving current, a driving voltage, or a duty of each of the multiple fan circuits.

13. The cooling fan system of claim 1, wherein a current rotational speed vector of the multiple fan circuits is positively correlated with the current electrical parameter vector.

14. The cooling fan system of claim 1, wherein the system coefficient table established during the test procedure is stored in the management controller or the multiple fan circuits.

15. A control method for controlling a cooling fan system, wherein the cooling fan system includes multiple fan circuits and a management controller, wherein the multiple fan circuits are configured to drive corresponding multiple fan devices according to corresponding multiple pulse width modulation (PWM) signals, and the management controller is configured to detect a fault prediction status of the multiple fan circuits; the control method comprising:
during a test procedure, performing feedback control of a current rotational speed vector of the multiple fan circuits to a target rotational speed vector according to a rotational speed feedback signal returned from each of the multiple fan circuits, and establishing a system coefficient table based on a predetermined electrical parameter vector corresponding to the target rotational speed vector, wherein the predetermined electrical parameter vector is returned from the multiple fan circuits, and wherein the system coefficient table includes the target rotational speed vector and the corresponding predetermined electrical parameter vector or a corresponding electrical parameter threshold vector; and
during an operation procedure, determining an operation rotational speed vector according to an environmental condition, and performing feedback control of the current rotational speed vector of the multiple fan circuits to the operation rotational speed vector, and subsequently detecting the fault prediction status of the multiple fan circuits based on the system coefficient table, wherein the fault prediction status corresponds to a condition in which a current electrical parameter vector of the multiple fan circuits exceeds the electrical parameter threshold vector.

16. The control method of claim 15, wherein the test procedure further includes: determining the target rotational speed vector according to a rotational speed range vector, wherein the rotational speed range vector includes multiple target rotational speed vectors.

17. The control method of claim 16, wherein the test procedure further includes: determining the rotational speed range vector according to a system default or by a user.

18. The control method of claim 16, wherein the system coefficient table includes an individual system coefficient table of each of the multiple fan circuits;
wherein in the individual system coefficient table corresponding to a selected one of the multiple fan circuits, the target rotational speed vector includes multiple target rotational speeds of the selected fan circuit and a fixed target rotational speed of others of the multiple fan circuits, and the predetermined electrical parameter vector includes multiple predetermined electrical parameters of the selected fan circuit;
wherein the test procedure further includes: establishing the individual system coefficient table of the selected fan circuit according to the multiple target rotational speeds of the selected fan circuit, the fixed target rotational speed of the others of the multiple fan circuits, and the corresponding multiple predetermined electrical parameters.

19. The control method of claim 16, wherein the system coefficient table includes an individual system coefficient table of each of the multiple fan circuits;
wherein in the individual system coefficient table corresponding to each of the multiple fan circuits, the target rotational speed vector includes multiple target rotational speeds of all of the multiple fan circuits, and the predetermined electrical parameter vector includes multiple predetermined electrical parameters of all of the multiple fan circuits;
wherein the test procedure further includes: establishing the individual system coefficient table of each of the multiple fan circuits according to the multiple target rotational speeds of all of the multiple fan circuits and the corresponding multiple predetermined electrical parameters.

20. The control method of claim 16, wherein the test procedure or the operation procedure further includes: controlling a communication between the management controller and the multiple fan circuits through a serial bus communication method so as to control and adjust the multiple fan circuits and detect the fault prediction status of the multiple fan circuits.

21. The control method of claim 20, wherein the test procedure or the operation procedure includes: controlling the communication between the management controller and the multiple fan circuits through a serial data line and a serial clock line so as to control and adjust the multiple fan circuits and detect the fault prediction status of the multiple fan circuits.

22. The control method of claim 15, wherein the test procedure or the operation procedure further includes: in a driving mode, transmitting the multiple PWM signals to the corresponding multiple fan circuits and receiving a current rotational speed vector returned from the corresponding multiple fan circuits so as to perform feedback control of the current rotational speed vector according to the target rotational speed vector; and
in a communication mode, transmitting multiple clock signals to the corresponding multiple fan circuits and receiving the predetermined electrical parameter vector or a current electrical parameter vector returned from the corresponding multiple fan circuits so as to detect the fault prediction status of the multiple fan circuits.

23. The control method of claim 15, wherein the operation procedure further includes: reading or calculating the electrical parameter threshold vector corresponding to the operation rotational speed vector according to the system coefficient table so as to detect the fault prediction status of the multiple fan circuits.

24. The control method of claim 15, wherein the environmental condition includes a system temperature, a system load, or an airflow resistance of the cooling fan system.

25. The control method of claim 15, wherein the current electrical parameter vector includes a driving current, a driving voltage, or a duty of each of the multiple fan circuits.

26. The control method of claim 15, wherein a current rotational speed vector of the multiple fan circuits is positively correlated with the current electrical parameter vector.

27. The control method of claim 15, wherein the test procedure further includes: storing the system coefficient table in the management controller or the multiple fan circuits.
